(19) United States
(12) Patent Application Publication
(10) Pub. No.: US 2013/0222118 A1
(43) Pub. Date: Aug. 29, 2013

(54) METHOD OF PREDICTING TAG DETECTION PROBABILITY FOR RFID FRAMED SLOTTED ALOHA ANTI-COLLISION PROTOCOLS

(71) Applicant: EMAD FELEMBAN, MAKKAH (SA)

(72) Inventor: EMAD FELEMBAN, MAKKAH (SA)

(73) Assignee: UMM AL-QURA UNIVERSITY, MAKKAH (SA)

(21) Appl. No.: 13/407,714

(22) Filed: Feb. 28, 2012

(51) Int. Cl. G06K 7/01

(52) U.S. Cl. 340/10.2

(57) ABSTRACT

The method of predicting tag detection probability for RFID framed slotted ALOHA anti-collision protocols is uses recursive calculations to accurately estimate the probability of discovering RFID tags in a multiple rounds discovery system. First, the method estimates the probability of detecting a given number of tags in a single round. Then, using a probability map, the method estimates the probability of detecting the given number of tags in multiple rounds. The probabilities are used to adjust the number of slots in a frame and the number of interrogation rounds used by the RFID tag reader to minimize collisions and optimize tag reading time.

### BACKGROUND OF THE INVENTION

1. Field of the Invention

The present invention relates to the prevention of collision in radio frequency identification (RFID) tag networks, and particularly to a method of predicting tag detection probability for RFID framed slotted ALOHA anti-collision protocols.

2. Description of the Related Art

In radio frequency identification (RFID) systems, a major problem of interest is the collision between RFID tags. Such collisions greatly lower the efficiency of the overall RFID system. ALOHA-type algorithms are relatively common in the development of anti-collision protocols, due to their relative simplicity. The ALOHA-type algorithms, however, are limited by the number of tags being read, and only show good performance when the number of tags to be read is relatively small. In the ALOHA algorithms, the number of slots used increases exponentially based upon the increase of the number of tags to be read.

Tag collision occurs when an RFID reader cannot identify the data from a particular tag when more than one tag occupies the same radio frequency (RF) communication channel at the same time. Solutions to the problem of tag collision focus on either the increase of data transmission speed by extending frequency bandwidth, or the increase of tag identification efficiency by minimizing tag collisions. Due to the difficulties in extending frequency bandwidth, and due to the limited number of usable frequency bands, greater focus is placed on the reduction of tag collisions to increase tag identification efficiency.

The slotted ALOHA algorithm is a tag identification method in which each tag transmits its serial number to the RFID tag reader in the slot of a frame, and the reader identifies the tag when it receives the serial number of the tag without collision. A “time slot”, as used in the slotted ALOHA scheme, is a time interval in which tags transmit their serial numbers. The reader identifies a tag when a time slot is occupied by only one tag. The framed slotted ALOHA algorithm uses “frames”. A “frame” is a time interval between requests of a reader, and consists of a number of slots. A read cycle is a tag identifying process that consists of a frame.

In framed slotted ALOHA-based anti-collision protocols, the reader begins each interrogation round by informing all of the tags about the round size in terms of time slots. Each tag then selects a random time slot and sends its identifier in that time slot. The probability of tag collision depends on the frame size. The reader then repeats the interrogation rounds until all tags are identified.

Due to the wide variety of RFID tag network configurations, and the wide variety of variations on ALOHA-type algorithms and, particularly, framed slotted ALOHA algorithms, it is necessary to test each configuration and each anti-collision scheme for efficiency. It would obviously be desirable to provide a predictive model for tag detection probability in RFID framed slotted ALOHA anti-collision protocols.

Thus, a method of predicting tag detection probability for RFID framed slotted ALOHA anti-collision protocols solving the aforementioned problems is desired.

### SUMMARY OF THE INVENTION

The present invention relates to the prevention of collision in radio frequency identification (RFID) tag networks, and particularly to a method of predicting tag detection probability for RFID framed slotted ALOHA anti-collision protocols. Using recursive calculations, the present method accurately estimates the probability of discovering RFID tags in a multiple rounds discovery system. First, the method estimates the probability of detecting a given number of tags in a single round. Then, using a probability map, the method estimates the probability of detecting the given number of tags in multiple rounds.

The method includes the following steps: (a) calculating a probability p that a single RFID tag out of n RFID tags randomly selects a unique time slot out of s time slots for identification transmission to an RFID tag reader within one round of tag reading as

$$p ( n , s ) = ( \begin{matrix}n \\ 1\end{matrix} ) ( \begin{matrix}1 \\ s\end{matrix} ) {( 1 - \frac{1}{s} )}^{n - 1} ,$$

where n and s are integers greater than or equal to one, and storing the calculated p(n,s) in computer readable memory; (b) establishing a maximum number of RFID tags that can be identified by the RFID tag reader within a single round of RFID tag reading m(n,s) as m(n,s)=0 if s=1, m(n,s)=s−1 if n>s, and m(n,s)=n if n≦s, and storing the calculated m(n,s) in the computer readable memory; (c) iteratively calculating a probability qᵢ(n,s) that i RFID tags will be identified within a single round of RFID tag reading, wherein i is an integer, as qᵢ(n,s)=1 if n=1, qᵢ(n,s)=0 if n≦s and i=n−1, qᵢ(n,s)=0 if s=1 and n>1, and if otherwise,

$${q}_{i} ( n , s ) = ( \begin{matrix}s \\ i\end{matrix} ) [ {\prod }_{j = 0}^{i - 1} p ( n - j , s - j ) ] \times l ( n - i , s - i )$$

for i=1 to m(n,s), where

$$l ( n - i , s - i ) = 1 - {\sum }_{k = 1}^{m ( n - i , s - i )} {q}_{k} ( n - i , s - i ) ,$$

where k is an integer, and storing the calculated values for qᵢ(n,s) in the computer readable memory; (d) iteratively calculating a probability that the n RFID tags are identified by the RFID tag reader within r rounds of tag reading bₛⁿ(r,n) as bₛⁿ(r,n)=qₙ(n,s) if r=1, otherwise:

$${b}_{s}^{n} ( r , n ) = {\sum }_{k = 0}^{n} [ {q}_{k} ( n - ( n - k ) , s ) \times {b}_{s}^{n} ( r - 1 , n - k ) ] ;$$

and (e) optionally displaying the calculated probability bₛⁿ(r,n) on a display.

These and other features of the present invention will become readily apparent upon further review of the following specification and drawings.

### BRIEF DESCRIPTION OF THE DRAWINGS

FIG. 1 is a block diagram illustrating system components of a system for implementing a method of predicting tag detection probability for RFID framed slotted ALOHA anti-collision protocols according to the present invention.

FIG. 2 diagrammatically illustrates a two-dimensional probability map in a method of predicting tag detection probability for RFID framed slotted ALOHA anti-collision protocols.

Similar reference characters denote corresponding features consistently throughout the attached drawings.

### DETAILED DESCRIPTION OF THE PREFERRED EMBODIMENTS

The present invention relates to the prevention of collision in radio frequency identification (RFID) tag networks, and particularly to a method of predicting tag detection probability for RFID framed slotted ALOHA anti-collision protocols. The following is based on an RFID network with a single RFID tag reader and n RFID tags. In real-world applications, the number of tags, n, is usually known. Thus, in the following, it is assumed that n is known, or effective population estimation algorithms are available for accurate estimation of n.

The RFID tag reader selects the frame size s in terms of time slots and announces the frame size s to the tags. Each tag then selects a random time slot in which to transmit its identification code. The reader can only identify tags that have selected unique time slots. Thus, when at least two tags select the same time slot, a tag collision occurs and the two or more tags are not identified. The reader continues the interrogation process for r rounds. In the following, once a tag has been identified, it is muted in subsequent interrogation rounds (i.e., the tag will not respond to a further reader request). Further, a fixed frame size is assumed.

In order to identify a tag during an arbitrary slot time a out of s slots in a round, exactly one tag out of n tags selects that slot and transmit its identification code. In the following, slot a is referred to as a “discovery slot”. The probability p(n,s) that an arbitrary slot is a discovery slot (i.e., exactly one tag transmits during that slot) is given by:

$$p ( n , s ) = ( \begin{matrix}n \\ 1\end{matrix} ) ( \begin{matrix}1 \\ s\end{matrix} ) {( 1 - \frac{1}{s} )}^{n - 1} . \qquad ( 1 )$$

In the following, m(n,s) represents the maximum number of tags that can be identified during a single interrogation round given n tags competing for s slots. m(n,s) is then given as:

$$m ( n , s ) = \{ \begin{matrix}0 if s = 1 \\ s - 1 if n > s \\ n if n \leq s\end{matrix} . \qquad ( 2 )$$

Then, the probability qᵢ(n,s) of identifying exactly one tag out of n tags during an interrogation round that consists of s slots is given by:

$${q}_{l} ( n , s ) = ( \begin{matrix}s \\ 1\end{matrix} ) p ( n , s ) l ( n - 1 , s - 1 ) \qquad ( 3 )$$

where l(n−1,s−1) is the probability that none of the remaining (s−1) slots is a discovery slot. Alternatively, l(n−1,s−1) can be defined also as the probability that none of the remaining (n−1) tags is identified during the remaining (s−1) slots. The term p(n,s) is the probability of having an arbitrary discovery slot, and

$$( \begin{matrix}s \\ 1\end{matrix} )$$

is the number of ways that this arbitrary slot can be selected.

The probability qᵢ(n,s) of identifying i tags (1≦i≦m(n,s)) in one interrogation round is given by:

$$\begin{matrix}{q}_{i} ( n , s ) = \{ \begin{matrix}1 if n = 1 \\ 0 if n \leq s and i = n - 1 \\ 0 if s = 1 and n > 1 ;\end{matrix} \\ otherwise , & ( 4 a ) \\ {q}_{i} ( n , s ) = ( \begin{matrix}s \\ i\end{matrix} ) [ {\prod }_{j = 0}^{i - 1} p ( n - j , s - j ) ] \times l ( n - i , s - i ) .. & ( 4 b )\end{matrix}$$

Equations (4a) and (4b) may be used to calculate the probability mass function of the number of tags that can be identified in one interrogation round. The probability l(n−i,s−i) is defined as the probability that none of the remaining (s−i) slots are discovery slots, or alternatively, it is the probability that no discovery slot exists among (s−i) slots. l(n−i ,s−i) is given by:

$$l ( n - i , s - i ) = {q}_{0} ( n - i , s - i ) = 1 - {\sum }_{k = 1}^{m ( n - i , s - i )} {q}_{k} ( n - i , s - i ) .. \qquad ( 5 )$$

With regard to equation (2), the RHO tag reader can only identify up to m(n,s) tags in one interrogation round. In order to estimate the probability that k tags are identified when the whole interrogation process ends (i.e., after r rounds), it is necessary to keep track of different possibilities that lead to identifying the k tags in r rounds. For example, assuming that node A discovered four nodes after three rounds of “Hello-Reply” exchanges, then node A may have discovered one node in the first round, zero nodes in the second round, and three nodes in the third round. Alternatively, node A may have discovered two nodes in the first round, one node in the second round and one node in the third round.

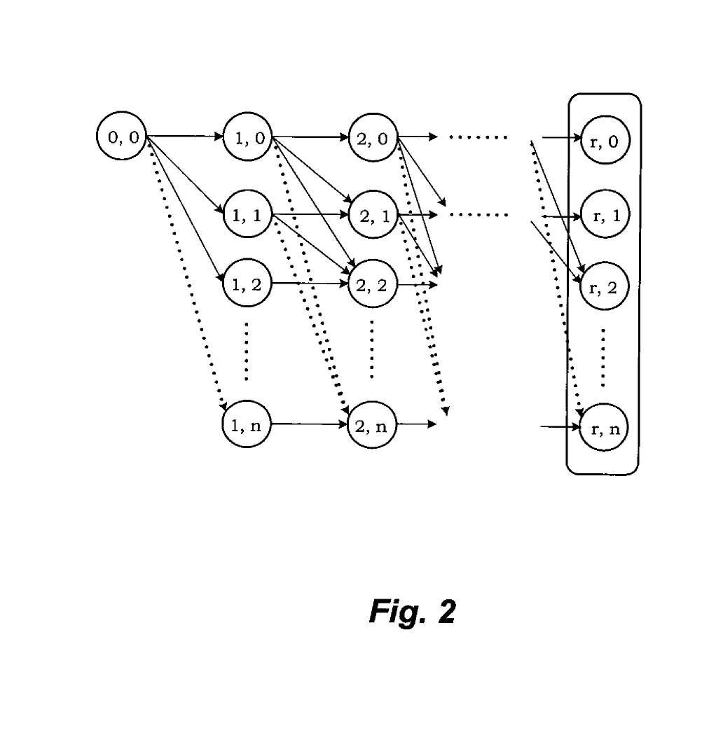

In order to account for such possibilities, subsequent interrogation rounds may be described as a two-dimensional probability map with (n+1)r states, as shown in FIG. 2. Each state (x,y) represents the probability that y tags are identified up to and including the x^{th} round. Any state (x,y) can only access states (x+1,y), (x+1,y₊1), . . . , (x+1,min(y+m(y,s),n)). The transition probabilities from states (x,a) to (x+1,b) are given by the probability mass of the number of identified tags in round x.

It should be noted that the states' probabilities are highly dependent on the number of tags n and the number of slots s. In fact, the probability bₛⁿ(x,y) of the state (x,y) with n tags and s slots per round is given by:

$$\begin{matrix}{b}_{s}^{n} ( x , y ) = {q}_{y} ( n , s ) if x = 1 and & ( 6 a ) \\ {b}_{s}^{n} ( x , y ) = {\sum }_{k = 0}^{n} [ {q}_{k} ( n - ( y - k ) , s ) \times {b}_{s}^{n} ( x - 1 , y - k ) ] if 1 < x \leq r .. & ( 6 b )\end{matrix}$$

Thus, the probability density function (PDF) of the number of tags identified after r rounds is given by calculating the probabilities bₛⁿ(r,0), bₛⁿ(r,1), . . . bₛⁿ(r,n).

In order to optimize the number of time slots per frame, s, and the number of rounds of interrogation, r, either the RFID tag reader's processor or a computer connected to the RFID tag reader by a wired connection or by a wireless connection may be programmed to execute the pseudocode summarized in Table 1. In Table 1, n is the number of tags, ε is the error margin for the probability of missing one tag, MaxSlots is the maximum permissible number of slots per frame, tᵣ is the time for the RFID tag to transmit its “Hello” message, and tₛ is the time slot duration, all of which are parameters input by the user. P_{Miss} is the probability of missing one tag, which is determined as in equations (6a) and (6b), described above. The algorithm minimizes the number of collisions while optimizing tag reading time to make efficient use of the frequency.

TABLE 1
Pseudocode for optimizing rounds and slots per frame

| └sₒₚₜᵢₘₐₗ, rₒₚₜᵢₘₐₗ┘ = FindOptimalConfiguration(n,ε,MaxSlots,tᵣ ,tₛ) | |
|---|---|
| DiscoveryTime = ∞ | |
| For s = 2 to MaxSlots | |
| notFound = TRUE | |
| r = 1 {Start with one round} | |
| While notFound do | |
| P_{Miss} = 1−bⁿₛ(r, n) | |
| newDiscoveryTime = r *(tᵣ + tₛ * s) | |
| if (P_{Miss} ≦ ε) & (newDiscoveryTime ≦ DiscoveryTime) | |
| DiscoveryTime = newDiscoveryTime | |
| sₒₚₜᵢₘₐₗ = s | |
| rₒₚₜᵢₘₐₗ = r | |
| notFound = FALSE | |
| else | |
| r = r +1 | {increase the number of rounds and try again with |
| | the same number of slots} |

```
      end if
    end While
  Next s {Increment the number of slots per frame up to MaxSlots}
end For
```

After executing the pseudocode, the RFID tag reader transmits its Hello message announcing the adjusted frame size and performs interrogations for the optimized number of rounds.

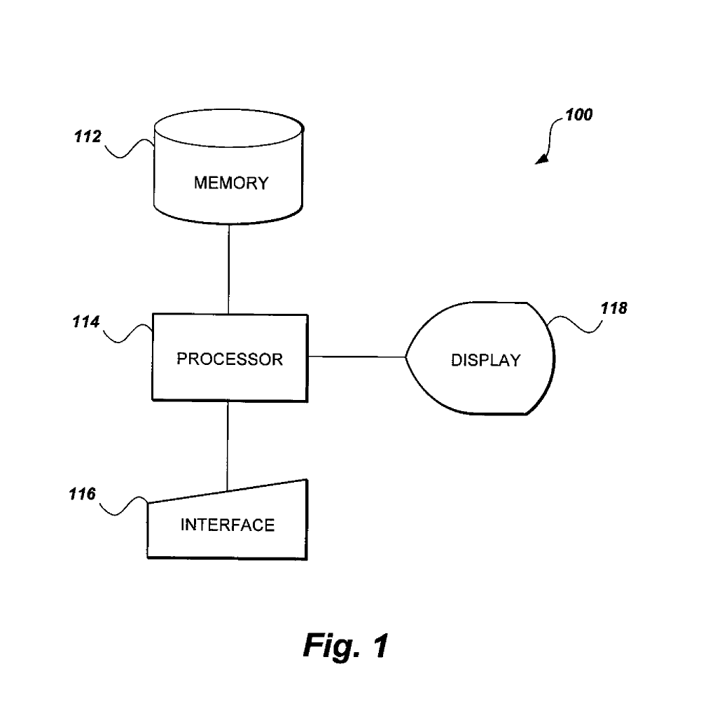

It should be understood that the calculations may be performed by any suitable computer system, such as that diagrammatically shown in FIG. 1, which may be connected to the RFID tag reader, either by Ethernet or USB cable, by a wireless network, by Bluetooth, or otherwise. Data is entered into system 100 via any suitable type of user interface 116, and may be stored in memory 112, which may be any suitable type of computer readable and programmable memory. Calculations are performed by processor 114, which may be any suitable type of computer processor and may be displayed to the user on display 118, which may be any suitable type of computer display.

Processor 114 may be associated with, or incorporated into, any suitable type of computing device, for example, a personal computer or a programmable logic controller. The display 118, the processor 114, the memory 112 and any associated computer readable recording media are in communication with one another by any suitable type of data bus, as is well known in the art.

Examples of computer-readable recording media include a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Alternatively, the calculations may be performed by an RFID tag reader having a suitable processor (a microprocessor, microcontroller, digital signal processor, application specific integrated circuit, or other tag reader signal processor) programmed to carry out the steps of the method.

It is to be understood that the present invention is not limited to the embodiments described above, but encompasses any and all embodiments within the scope of the following claims.

I claim:

1. A method of predicting tag detection probability for RFID framed slotted ALOHA anti-collision protocols, comprising the steps of:
(a) entering parameters into a processing unit of a radio frequency identification (RFID) system, the parameters including n number of tags to be read, ε representing an error margin for a probability of missing at least one tag, MaxSlots representing a maximum permissible number of time slots per frame, tᵣ representing a time for the RFID tag to transmit its “Hello” message, and tₛ representing a duration of the time slot;
(b) iteratively computing an optimal number of time slots, sₒₚₜᵢₘₐₗ and an optimal number of rounds, rₒₚₜᵢₘₐₗ, the iteratively computing being done by the processing unit and including, for a number of time slots s from 2 through MaxSlots, the steps of:
(i) initializing discovery time to infinity; and
(ii) for each s, beginning with the number of rounds, r, initialized to r=1, calculating the probability of missing at least one tag, P_{Miss}, such that P_{Miss}=1−bⁿₛ(r,n), calculating a new discovery time such that newDiscoveryTime=r*(tᵣ+tₛ*s); and if P_{Miss} is not greater than 6 and the new discovery time is not greater than the discovery time, resetting the discovery time to the new discovery time, setting sₒₚₜᵢₘₐₗ=s, and setting rₒₚₜᵢₘₐₗ=r, otherwise incrementing r by 1 and repeating step (ii) until P_{Miss} is not greater than ε and the new discovery time is not greater than the discovery time, wherein bⁿₛ(r,n) is a probability that the n RFID tags are identified by the RFID tag reader within r rounds of tag reading determined by the steps of
(1) calculating a probability p that a single RFID tag out of n RFID tags randomly selects a unique time slot out of s time slots for identification transmission to an RFID tag reader within one round of tag reading such that
$$p ( n , s ) = ( \begin{matrix}n \\ 1\end{matrix} ) ( \begin{matrix}1 \\ s\end{matrix} ) {( 1 - \frac{1}{s} )}^{n - 1} ,$$
wherein n and s are integers greater than or equal to one, the calculating being done by the processing unit;
(2) establishing a maximum number of RFID tags that can be identified by the RFID tag reader within a single round of RFID tag reading m(n,s) such that m(n,s)=0 if s=1, m(n,s)=s−1 if n>s, and m(n,s)=n if n≦s, the establishing being done by the processing unit;
(3) iteratively calculating a probability qᵢ(n,s) that i RFID tags will be identified within a single round of RFID tag reading, wherein i is an integer, such that qᵢ(n,s)=1 if n=1, qᵢ(n,s)=0 if n≦s and i=n−1, qᵢ(n,s)=0 if s=1 and n>1, and
$${q}_{i} ( n , s ) = ( \begin{matrix}s \\ i\end{matrix} ) [ {\prod }_{j = 0}^{i - 1} p ( n - j , s - j ) ] \times l ( n - i , s - i )$$
if otherwise, for i=1 to m(n,s), wherein
$$l ( n - i , s - i ) = 1 - {\sum }_{k = 1}^{m ( n - i , s - i )} {q}_{k} ( n - i , s - i ) ,$$
where k is an integer, the calculating being done by the processing unit; and
(4) iteratively calculating a probability that the n RFID tags are identified by the RFID tag reader within r rounds of tag reading bₛⁿ(r,n) such that bₛⁿ(r,n)=qₙ(n,s) if r=1 and otherwise
$${b}_{s}^{n} ( r , n ) = {\sum }_{k = 0}^{n} [ {q}_{k} ( n - ( n - k ) , s ) \times {b}_{s}^{n} ( r - 1 , n - k ) ] ,$$
the calculating being done by the processing unit; and
(c) adjusting an RFID tag reader in the system to read sₒₚₜᵢₘₐₗ slots per frame and to interrogate the n RFID tags for rₒₚₜᵢₘₐₗ rounds.

2. A processing unit for optimizing time slots per frame and rounds of interrogation in a system using RFID framed slotted ALOHA anti-collision protocols, the processing unit comprising:
(a) means for entering parameters into the processing unit, the parameters including n number of tags to be read, ε representing an error margin for a probability of missing at least one tag, MaxSlots representing a maximum permissible number of time slots per frame, tᵣ representing a time for the RFID tag to transmit its “Hello” message, and tₛ representing a duration of the time slot;
(b) means for iteratively computing an optimal number of time slots, sₒₚₜᵢₘₐₗ and an optimal number of rounds, rₒₚₜᵢₘₐₗ, the means including, for a number of time slots s from 2 it through MaxSlots:
(i) means for initializing discovery time to infinity; and
(ii) for each s, beginning with the number of rounds, r, initialized to r=1, means for iteratively calculating the probability of missing at least one tag, P_{Miss}, such that P_{Miss}=1−bⁿₛ(r,n), calculating a new discovery time such that newDiscovelyTime=r*(tᵣ+tₛ* s); and resetting the discovery time to the new discovery time, setting sₒₚₜᵢₘₐₗ=s, and setting rₒₚₜᵢₘₐₗ=r if P_{Miss} is not greater than ε and the new discovery time is not greater than the discovery time, and otherwise incrementing r by 1 until P_{Miss} is not greater than ε and the new discovery time is not greater than the discovery time, wherein bⁿₛ(r,n) is a probability that the n RFID tags are identified by the RFID tag reader within r rounds of tag reading, the processing unit having:
(1) means for calculating a probability p that a single RFID tag out of n RFID tags randomly selects a unique time slot out of s time slots for identification transmission to an RFID tag reader within one round of tag reading such that
$$p ( n , s ) = ( \begin{matrix}n \\ 1\end{matrix} ) ( \begin{matrix}1 \\ s\end{matrix} ) {( 1 - \frac{1}{s} )}^{n - 1} ,$$
wherein n and s are integers greater than or equal to one;
(2) means for establishing a maximum number of RFID tags that can be identified by the RFID tag reader within a single round of RFID tag reading m(n,s) such that m(n,s)=0 if s=1, m(n,s)=s−1 if n>s, and m(n,s)=n if n≦s;
(3) means for iteratively calculating a probability qᵢ(n,s) that i RFID tags will be identified within a single round of RFID tag reading, wherein i is an integer, such that qᵢ(n,s)=1 if n=1, qᵢ(n,s)=0 if n≦s and i=n−1, qᵢ(n,s)=0 if s=1 and n>1, and
$${q}_{i} ( n , s ) = ( \begin{matrix}s \\ i\end{matrix} ) [ {\prod }_{j = 0}^{i - 1} p ( n - j , s - j ) ] \times l ( n - i , s - i )$$
if otherwise, for i=1 to m(n,s), wherein
$$l ( n - i , s - i ) = 1 - {\sum }_{k = 1}^{m ( n - i , s - i )} {q}_{k} ( n - i , s - i ) ,$$
where k is an integer; and
(4) means for iteratively calculating a probability that the n RFID tags are identified by the RFID tag reader within r rounds of tag reading bₛⁿ(r,n) such that bₛⁿ(r,n)=qₙ(n,s) if r=1 and otherwise
$${b}_{s}^{n} ( r , n ) = {\sum }_{k = 0}^{n} [ {q}_{k} ( n - ( n - k ) , s ) \times {b}_{s}^{n} ( r - 1 , n - k ) ] ;$$
and
(c) means for adjusting an RFID tag reader in the system to read sₒₚₜᵢₘₐₗ slots per frame and to interrogate the n RFID tags for rₒₚₜᵢₘₐₗ rounds.

3. The processing unit according to claim 2, wherein said processing unit comprises a microprocessor incorporated into the RFID tag reader.

4. The processing unit according to claim 2, wherein said processing unit comprises a microcontroller incorporated into the RFID tag reader.

5. The processing unit according to claim 2, wherein said processing unit comprises a digital signal processor incorporated into the RFID tag reader.

6. The processing unit according to claim 2, wherein said processing unit comprises an application specific integrated circuit incorporated into the RFID tag reader.

7. The processing unit according to claim 2, wherein said processing unit comprises a computer connected to the RFID tag reader by a communication cable.

8. The processing unit according to claim 2, wherein said processing unit comprises a computer connected to the RFID tag reader by a wireless network.

9. A computer software product that includes a non-transitory storage medium readable by a processor, the non-transitory storage medium having stored thereon a set of instructions for predicting tag detection probability for RFID framed slotted ALOHA anti-collision protocols, the instructions comprising:
(a) a first sequence of instructions which, when executed by the processor, causes the processor to accept entry of parameters into a processing unit of a radio frequency identification (RFID) system, the parameters including n number of tags to be read, ε representing an error margin for a probability of missing at least one tag, MaxSlots representing a maximum permissible number of time slots per frame, tᵣ representing a time for the RFID tag to transmit its “Hello” message, and tₛ representing a duration of the time slot;
(b) a second sequence of instructions which, when executed by the processor, causes the processor to iteratively compute an optimal number of time slots, sₒₚₜᵢₘₐₗ and an optimal number of rounds, rₒₚₜᵢₘₐₗ, the iteratively computing including, for a number of time slots s from 2 through MaxSlots, instructions for:
(i) initializing discovery time to infinity; and
(ii) for each s, beginning with the number of rounds, r, initialized to r=1, calculating the probability of missing at least one tag, P_{Miss}, such that P_{Miss}=1−bⁿₛ(r,n), calculating a new discovery time such that newDiscoveryTime=r*(tᵣ+tₛ*s); and if P_{Miss} is not greater than ε and the new discovery time is not greater than the discovery time, resetting the discovery time to the new discovery time, setting sₒₚₜᵢₘₐₗ=s, and setting rₒₚₜᵢₘₐₗ=r, otherwise incrementing r by 1 and repeating step (ii) until P_{Miss} is not greater than 6 and the new discovery time is not greater than the discovery time, wherein bⁿₛ(r,n) is a probability that the n RFID tags are identified by the RFID tag reader within r rounds of tag reading determined by instructions for:
(1) calculating a probability p that a single RFID tag out of n RFID tags randomly selects a unique time slot out of s time slots for identification transmission to an RFID tag reader within one round of tag reading such that
$$p ( n , s ) = ( \begin{matrix}n \\ 1\end{matrix} ) ( \begin{matrix}1 \\ s\end{matrix} ) {( 1 - \frac{1}{s} )}^{n - 1} ,$$
wherein n and s are integers greater than or equal to one;
(2) establishing a maximum number of RFID tags that can be identified by the RFID tag reader within a single round of RFID tag reading m(n,s) such that m(n,s)=0 if s=1, m(n,s)=s−1 if n>s, and m(n,s)=n if n≦s;
(3) iteratively calculating a probability qᵢ(n,s) that i RFID tags will be identified within a single round of RFID tag reading, wherein i is an integer, such that qᵢ(n,s)=1 if n=1, qᵢ(n,s)=0 if n≦s and i=n−1, qᵢ(n,s)=0 if s=1 and n>1, and
$${q}_{i} ( n , s ) = ( \begin{matrix}s \\ i\end{matrix} ) [ {\prod }_{j = 0}^{i - 1} p ( n - j , s - j ) ] \times l ( n - i , s - i )$$
if otherwise, for i=1 to m(n,s), wherein
$$l ( n - i , s - i ) = 1 - {\sum }_{k = 1}^{m ( n - i , s - i )} {q}_{k} ( n - i , s - i ) ,$$
where k is an integer; and
(4) iteratively calculating a probability that the n RFID tags are identified by the RFID tag reader within r rounds of tag reading bₛⁿ(r,n) such that bₛⁿ(r,n)=qₙ(n,s) if and otherwise
$${b}_{s}^{n} ( r , n ) = {\sum }_{k = 0}^{n} [ {q}_{k} ( n - ( n - k ) , s ) \times {b}_{s}^{n} ( r - 1 , n - k ) ] ;$$
and
(c) a third sequence of instructions which, when executed by the processor, causes the processor to adjust an RFID tag reader in the system to read sₒₚₜᵢₘₐₗ slots per frame and to interrogate the n RFID tags for rₒₚₜᵢₘₐₗ rounds.
